(19) United States
(12) Patent Application Publication
(10) Pub. No.: US 2007/0205275 A1
(43) Pub. Date: Sep. 6, 2007

(54) Portable point of sale systems and methods

(75) Inventors: John Patrick Nicola, Aurora, CO (US); Steve Mathison, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/370,202

(22) Filed: Mar. 6, 2006

(51) Int. Cl. G06K 15/00; G07F 19/00

(52) U.S. Cl. 235/383; 235/379

(57) ABSTRACT

End-to-end transaction processing systems and methods provide for calculating an amount of a transaction, capturing a presentation instrument information from a customer presentation instrument with a portable POS device, transmitting the presentation instrument information to a PC-based POS system, and transmitting the presentation instrument information, a sales information, and an authorization request to an acquirer, transmitting the presentation information, the sales information, and the authorization request to an issuer, processing the presentation information, the sales information, and the authorization request to determine an approval or a denial, transmitting the approval or the denial to the acquirer; and transmitting the approval or the denial to the PC-based POS system.

### BACKGROUND OF THE INVENTION

This invention relates to point-of-sale devices and to point-of-sale transactions. More particularly, embodiments of this invention relate to portable point-of sale systems and methods.

In the sale of goods or services by a merchant to a customer, point-of-sale or point-of-service (“POS”) devices are often used by the merchant to complete a transaction. For example, a common cash register can be used to tally the cost of items purchased, accept cash payments, and return the proper amount of change. In some cases, such a register can be used in conjunction with a credit card reader. More particularly, the merchant can ring up a total amount due on the register, pass the credit card through a card reader to debit the customer account, and in turn the register recognizes the payment by credit card. While devices for completing such transactions exist, the functionality of such devices are often limited, leading to undesirable inefficiency and fraud risk in certain commercial and retail environments.

For example, known transaction systems often involve significant operating costs such as interchange fees for expenses related to processing transactions among different network and device providers. Further, when settling a transaction in a typical restaurant setting, the customer presents a credit card to a server, who then takes the card away from the customer's table to a POS terminal which is usually located near the common cash register, swipes the card through the POS terminal, and then returns to the table with the card and a transaction receipt. Such procedures can introduce unwanted inefficiencies in a busy restaurant environment, and can present opportunities for skimming and other credit card fraud when the credit card is not in the customer's possession. For these and other reasons, there remains a need for POS systems and methods of using such that overcome the limitations of currently known systems.

The instant invention addresses these and other unfulfilled needs by providing portable POS systems, devices, and methods for processing financial and other types of transactions.

### BRIEF SUMMARY OF THE INVENTION

Embodiments of the present invention provide methods and systems for processing credit card payments and other presentation instrument transactions using a portable POS device. Such devices may be used in a variety of circumstances and in a variety of ways. For example, the devices may be used by restaurateurs to increase efficiency and security for transactions conducted at their establishments. Advantageously, embodiments of the present invention provide a merchant having an existing PC-based POS system the benefit of augmenting the system with a portable POS device. Providing a portable POS device that is compatible with an existing PC-based POS system allows the merchant to extend their existing transaction capabilities to an expanded service area. Embodiments also provide the merchant with the capability of replacing an existing terminal POS system with a portable POS device and PC-based POS system, or with a portable POS device with cellular modem.

Embodiments of the present invention also provide systems and methods that involve a complete end-to-end infrastructure to support an entire transaction process, including integration between a portable POS device and a PC-based POS system, transaction transport, transaction processing and switching, and transaction settlement capabilities. In some embodiments, all of these capabilities are provided or supported by a single entity, such as First Data Corporation, or subsidiaries or affiliates thereof.

In a first aspect, embodiments of the present invention provide a method of processing a transaction. The method includes reading a unique identifier from an information storage medium of a presentation instrument with a portable point of sale device, transmitting the unique identifier from the portable point of sale device to a PC based point of sale system according to a wireless network protocol, transmitting the unique identifier from the PC-based point of sale system to a host computer system, processing the transaction with the host computer system based on the unique identifier, transmitting an authorization request to an issuing entity to obtain an authorization response, wherein authorization request is based on the processed transaction, transmitting the authorization response to the portable point of sale device. The unique identifier can be transmitted from the PC-based point of sale base terminal to the host computer system via a non wireless transaction processing network. The method can also include displaying transaction information on the portable point of sale device. In some embodiments, the method includes accepting a customer payment authorization with the portable point of sale device. The presentation instrument can be a PIN debit instrument, a signature debit instrument, a credit instrument, or a stored value instrument. In some embodiments, the unique identifier can be transmitted from the portable point of sale device to the PC-based point of sale system according to a protocol such as a Bluetooth protocol, a Wireless Fidelity (WiFi) protocol, a Worldwide Interoperability for Microwave Access (WiMax) protocol, or a cellular data protocol. The method can also include reading the unique identifier with a reader of the portable point of sale device, where the reader includes a smart card reader, a magnetic strip reader, a bar code reader, a Radio Frequency reader, or a Near Field Communication reader.

In another aspect, embodiments of the present invention provide a method of processing a transaction. The method includes reading a unique identifier from an information storage medium of a presentation instrument with a portable point of sale device, transmitting the unique identifier from a cellular data modem of the portable point of sale device to host computer system, and processing the transaction with the host computer system based on the unique identifier. The method can also include displaying transaction information on the portable point of sale device. Further, the method may include accepting a customer payment authorization with the portable point of sale device. In some instances, the presentation instrument can be a PIN debit instrument, a signature debit instrument, a credit instrument, or a stored value instrument. The unique identifier can be transmitted from the portable point of sale device to the PC-based point of sale system according to a cellular data protocol. In some embodiments, the method can also include reading the unique identifier with a reader of the portable point of sale device, where the reader includes a smart card reader, a magnetic strip reader, a bar code reader, a Radio Frequency reader, or a Near Field Communication reader.

In yet another aspect, embodiments of the present invention include a system for processing a transaction. The system can include a portable point of sale device having an input for receiving a unique identifier from an information storage medium of a presentation instrument, and a first wireless communication module. The system can also include a PC-based point of sale system having a second wireless communication module configured to communicate with the first wireless communication module via a wireless network protocol such that the unique identifier can be wirelessly transmitted from the portable point of sale device to the point of sale base terminal. The system can further include a host computer system configured to receive the unique identifier from the point of sale system and to process a transaction based on the unique identifier. In some aspects, the portable point of sale device can be configured to accept a presentation instrument such as a PIN debit instrument, a signature debit instrument, a credit instrument, or a stored value instrument. The portable point of sale device can be configured to prompt a user for a PIN number. In some embodiments, the cellular data protocol can include a Cellular Digital Packet Data (CDPD) protocol, a General Packet Radio Service (GSM/GPRS) protocol, or a Code Division Multiple Access (CDMA) protocol. The portable point of sale device can include a PIN pad. In some instances, the portable point of sale device can include a reader that includes a smart card reader, a magnetic strip reader, a bar code reader, a Radio Frequency reader, or a Near Field Communication reader.

In still another aspect, embodiments of the present invention provide a transaction processing method. The method can include calculating an amount of a transaction, capturing a presentation instrument information from a customer presentation instrument with a portable POS device, transmitting the presentation instrument information to a PC-based POS system, transmitting the presentation instrument information, a sales information, and an authorization request to an acquirer, and transmitting the presentation information, the sales information, and the authorization request to an issuer. The method may also include processing the presentation information, the sales information, and the authorization request to determine an approval or a denial, transmitting the approval or the denial to the acquirer, and transmitting the approval or the denial to the PC-based POS system.

In yet another aspect, the present invention provides a method of processing a transaction. The method can include reading a unique identifier from an information storage medium of a presentation instrument with a portable point of sale device, transmitting the unique identifier from the portable point of sale device to a point of sale base terminal according to a wireless network protocol, transmitting the unique identifier from the point of sale base terminal to a host computer system, and processing the transaction with the host computer system based on the unique identifier. In some embodiments, a transaction processing method can include transmitting the unique identifier from the point of sale base terminal to the host computer system via a non-wireless transaction processing network. In some embodiments, the method can include displaying transaction information on the portable point of sale device to a customer. The method may also include accepting payment authorization into the portable point of sale device from a customer. Relatedly, the method may include reading the unique identifier from a presentation instrument such as a PIN debit instrument, a signature debit instrument, a credit instrument, or a stored value instrument. In some cases, the method may include transmitting the unique identifier from the portable point of sale device to the point of sale base terminal according to a protocol selected such as a Bluetooth protocol, a Wireless Fidelity (WiFi) protocol, a Worldwide Interoperability for Microwave Access (WiMax) protocol, or a cellular data protocol. In some instances, the method may involve reading the unique identifier with a reader of the portable point of sale device. The reader may include, for example, a smart card reader, a magnetic strip reader, a bar code reader, a Radio Frequency reader, or a Near Field Communication reader.

In some aspects, embodiments of the present invention include a retrofit POS terminal system. The retrofit POS terminal system may include, for example, a portable point of sale device having an input for receiving a unique identifier from an information storage medium of a presentation instrument, and a first wireless communication module. The retrofit system may also include an adapter for a PC-based POS system or a POS base terminal. The adapter may include a second wireless communication module that is configured to communicate with the first wireless communication module via a wireless network protocol such that the unique identifier can be wirelessly transmitted from the portable point of sale device to the adapter. The adapter can be configured to transmit the unique identifier to an input interface of the point of sale base terminal. In some embodiments, the portable POS device is configured to accept a presentation instrument such as a PIN debit instrument, a signature debit instrument, a credit instrument, or a stored value instrument. Relatedly, the portable POS device can be configured to prompt a user for a PIN number. The wireless network protocol can include a Bluetooth protocol, a Wireless Fidelity (WiFi) protocol, a Worldwide Interoperability for Microwave Access (WiMax) protocol, a cellular data protocol, or the like. In some instances, the portable POS device includes a PIN pad. In some instances, the portable POS device includes a smart card reader, a magnetic strip reader, a bar code reader, a Radio Frequency reader, a Near Field Communication reader, or the like.

In one aspect, embodiments of the present invention provide a method of retrofitting a PC-based POS system or a POS base terminal. The method can include providing a portable POS device having an input for receiving a unique identifier from an information storage medium of a presentation instrument, and a first wireless communication module. The method can also include coupling an adapter to the PC-based POS system or POS base terminal, where the adapter includes a second wireless communication module that is configured to communicate with the first wireless communication module via a wireless network protocol, such that the unique identifier can be wirelessly transmitted from the portable point of sale device to the adapter. The adapter can be configured to transmit the unique identifier to an input interface of the point of sale base terminal. The portable POS device can be configured to accept a presentation instrument such as a PIN debit instrument, a signature debit instrument, a credit instrument, a stored value instrument, or the like. In some embodiments, the wireless network protocol includes a Bluetooth protocol, a Wireless Fidelity (WiFi) protocol, a Worldwide Interoperability for Microwave Access (WiMax) protocol, a cellular data protocol, or the like.

### BRIEF DESCRIPTION OF THE DRAWINGS

FIG. 1 shows a transaction processing system according to one embodiment of the present invention.

FIG. 2 shows a transaction processing system according to one embodiment of the present invention.

FIG. 3 depicts a portable POS device and PC-based POS system according to one embodiment of the present invention.

FIG. 4 illustrates a transaction processing method according to one embodiment of the present invention.

FIG. 5 shows a transaction processing system according to one embodiment of the present invention.

### DETAILED DESCRIPTION OF THE INVENTION

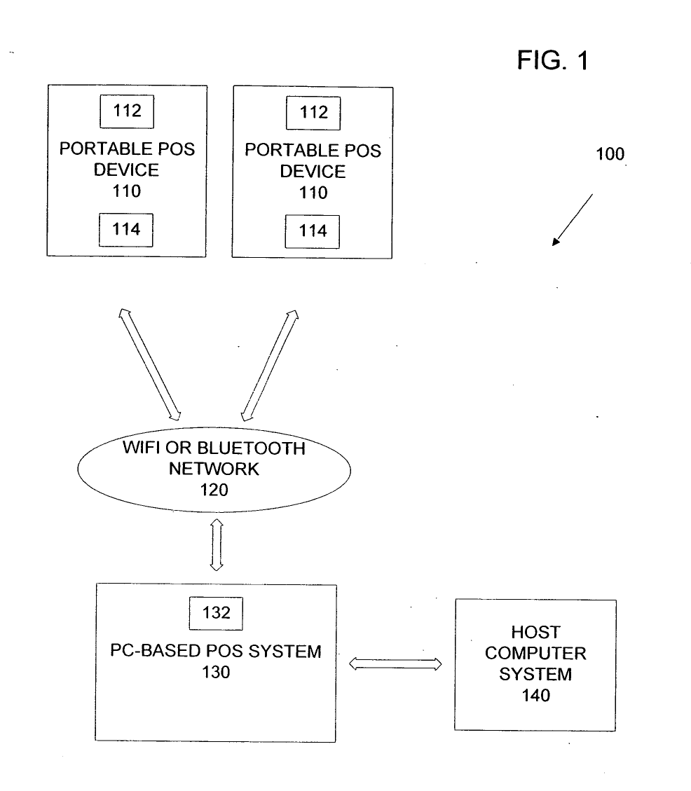

Various embodiments of the present invention are directed to a portable POS device suitable for convenient use with customer transactions. In some embodiments, a portable POS device is communicably coupled with a PC-based POS system. A portable POS device may also be communicably coupled with a host computer system. Such portable POS devices can be used in conjunction with credit cards and other presentation instruments, and are well suited for implementation in the restaurant industry. Turning now to the drawings, FIG. 1 illustrates a transaction processing system 100 according to one embodiment of the present invention. Transaction processing system 100 includes one or more portable POS devices 110, a PC-based POS system 130 or base unit, and a host computer system 140. Portable POS device 110 can include an input 112 for receiving a unique identifier from an information storage medium of a presentation instrument 150, and a wireless communication module 114. PC-based POS system 130 can include a wireless communication module 132. Typically, input 112 is coupled with or includes a reader such as a smart card reader, a magnetic strip reader, a bar code reader, a Radio Frequency reader, a Near Field Communication reader, and the like.

Wireless communication modules 114 and 132 can be configured to communicate via a wireless network protocol over a network 120 such that the unique identifier can be wirelessly transmitted from portable POS device 110 to PC-based POS system 130. In some embodiments, wireless transmission can be accomplished via WiFi, Bluetooth, or cellular protocols or connectivities. WiFi can include a set of compatibility standards for wireless local area networks (WLAN) based on IEEE 802.11 specifications. Bluetooth can be supported by low-power, short-range wireless technology, which can provide a replacement for a serial cable. Cellular can include a wireless network operating in the 800 MHz range that uses a grid, where a region is carved into different cells, each with it's own antenna. Transmissions can be “handed off” from cell to cell. Relatedly, portable POS device 110 may be integrated into PC-based POS system 130.

Host computer system 140 can be configured to receive the unique identifier from PC-based POS system 130 over a network 150. In some embodiments, network 150 includes a standard POS communication line. Standard POS communication lines can involve technologies such as Dial-up, Wireless, Internet Transport, Frame Relay, and Very Small Aperture Terminal (VSAT). Embodiments of Dial-up include networks offering connectivity over analog telephone lines. Embodiments of Wireless include technology that eliminates substitutes for fixed wire telephone lines, enabling process payment from virtually any location. Wireless can be faster than Dial-up, and can eliminate the need for a business phone and its supporting resources. Merchants with remote locations such as kiosks can benefit from mobile wireless technology. Embodiments of Internet Transport include suites of communications protocols used to connect hosts on the internet, such as Transmission Control Protocol/Internet Protocol. Embodiments of Frame Relay include packet-switching protocols for connecting devices on a Wide Area Network (WAN). Embodiments of VSAT include networks that provide satellite transmission of data, voice, and video to and from corporate and field offices.

Typically, host computer system 140 processes a transaction, or part of a transaction, based on the unique identifier. Often, such processing involves authorization and settlement. In some embodiments, components of transaction system 100 such as portable POS devices 110 and/or PC-based POS system 130 are developed and maintained by the same entity or provider or subsidiaries or affiliates thereof. Thus, the present systems can reduce otherwise inefficient or unwanted operating costs such as interchange fees for expenses related to processing transactions among-different network and device providers.

In some embodiments, portable POS device 110 is a secure device which can interface with a PC-based POS system 130, a POS base terminal, an Electronic Cash Register (“ECR”), a Personal Digital Assistant (“PDA”), or other such devices. Portable POS device 110 can provide software and/or hardware modules configured to confer functionality which is used by a consumer in a retail environment, such as Personal Identification Number (“PIN”) entry, clear text entry, signature capture, and the like. Such features can increase efficiency in table side or point of sale service, in addition to reducing unwanted complications related to chargebacks. In various embodiments, portable POS device 110 can be used as a stand alone unit capable of operation apart from PC-based POS system 130 or other suitable base system.

Either separate or in conjunction, PC-based POS system 130 and portable POS device 110 can support a variety of functions together with a range of transactional services offered through a retailer maintaining PC-based POS system 130 and/or portable POS device 110. Such transactional services can include, but are not limited to, commercial, retail, and service transactions, money transfers, money orders, checking and check guarantee services, and the like. For example, PC-based POS system 130 and portable POS device 110 can be configured to accept presentation instruments in a restaurant facility or any type of eating establishment. Portable POS device 110 can be configured to display restaurant-specific transaction information, to accept customer payment authorization, and the like. In some instances, portable POS device 110 may display menu items. In some embodiments, portable POS device may display the date and amount of the bill, a tip amount, and a description of the food, beverage, or other item or service purchased. Other display entries may include the name or other identifying indicia of the server or restaurant employee, and the name and location of the restaurant. Transaction system 100 can be configured to accept and manage any of a variety of payment methods, including credit cards, gift cards, debit cards, checks, and the like. Transaction system 100 may also include software to provide a patron database, reporting tools, and payment receipt managing functionality based on calendar date, patron, payment type, employee, and the like. PC-based POS system 130 or other components of transaction system 100 may be configured to run on any of a variety of operating systems, including Windows® or Linux. Further, such systems or components can be configured to support any of a variety of POS standards, including OPOS, JavaPOS, and UnifiedPOS.

In some embodiments, transactional services can be provided by one or more third party suppliers maintaining host computer systems 140 accessible via PC-based POS system 130 and/or portable POS device 110. For example, money orders may be requested and printed by PC-based POS system 130 and/or portable POS device 110 through access to a first supplier's transaction system, while check guarantee services are provided by PC-based POS system 130 and/or portable POS device 110 through access to a second supplier's transaction system.

In some embodiments, portable POS device 110 provides the identical functionality provided by PC-based POS system 130, albeit in a form accessible to a customer. Thus, for example, PC-based POS system 130 may be tailored for operation by a merchant or restaurateur, while the same functionality is implemented in portable POS device 110 and tailored for operation by a customer. In particular embodiments, PC-based POS system 130 is mounted near a cash register at a check out stand in a retail outlet or restaurant, while portable POS device 110 is mounted on the check out stand or any other suitable location that is accessible to a customer. In this way, both the merchant and the customer can interact with similar devices to effectuate a transaction.

In other embodiments, PC-based POS system 130 includes a number of components while portable POS device 110 includes only a subset of such components. Thus, for example, a customer is capable of effectuating a limited number of transactions, or only a portion of other transactions via portable POS device 110, whereas the merchant is capable of effectuating all transactions via PC-based POS system 130.

In yet other embodiments, PC-based POS system 130 includes some components and portable POS device 110 includes a complimentary set of components. Thus, for example, functions useful for gathering information from a customer in relation to a transaction are deployed as part of portable POS device 110, while components used by a merchant in relation to a transaction are deployed as part of PC-based POS system 130.

In some embodiments, portable POS device 110 is communicably coupled to PC-based POS system 130 via a cable. In other embodiments, portable POS device 110 is communicably coupled to PC-based POS system 130 via a Radio Frequency (“RF”) or line-of-sight connection. Other suitable wireless network connectivity protocols between portable POS device 110 and PC-based POS system 130 include Bluetooth protocol (e.g. IEEE 802.15.1) and other industrial specifications for wireless personal area networks (PANs), Wireless Fidelity (WiFi) protocol, Worldwide Interoperability for Microwave Access (WiMax) protocol, and cellular data protocol. WiFi protocol can include, for example, an IEEE 802.11a protocol, an IEEE 802.11b protocol, an IEEE 802.11g protocol, and other Wireless Local Area Network (WLAN) protocols. Similarly, WiMax protocol can include, for example, an IEEE 802.16 protocol.

While the preceding discussion identifies a variety of interconnects between PC-based POS system 130 and portable POS device 110, one of ordinary skill in the art will recognize a number of other types of interconnection capable of communicably coupling PC-based POS system 130 with portable POS device 110. Furthermore, it should be recognized that more than one portable POS device 110 can be associated with a single PC-based POS system 130. Alternatively, in some embodiments, PC-based POS system 130 is implemented without an associated portable POS device 110.

In some embodiments, PC-based POS system 130 is an intelligent, counter top, merchant activated POS device targeted for use in a variety of retail environments. Some of the retail environments include capability to consummate restaurant or retail purchases; transfer money; provide credit, debit, gift, and stored value cards and transaction capability for such cards, including, but not limited to, phone cards and/or gift cards; perform fraud detection and surveillance; and the like. In some embodiments, PC-based POS system 130 operates as a single self contained device, although in most embodiments, PC-based POS system 130 operates in conjunction with one or more portable POS devices 110.

PC-based POS system 130 and host computer system 140 may be communicably coupled via any of a variety of networks, including for example, a TCP/IP compliant virtual private network (“VPN”), the Internet, a local area network (“LAN”), a wide area network (“WAN”), a telephone network, a cellular telephone network, an optical network, a wireless network, a non-wireless network, or any other similar communication network or transaction processing network. In particular embodiments, transaction network 150 provides message based communications between PC-based POS system 130 and host computer system 140.

In some embodiments, communication network 150 includes a combination of a variety of network types. For example, in one embodiment, communication network 150 includes the Internet for communicating between PC-based POS system 130 and host computer system 140, and a VPN for communicating between PC-based POS system 130 and a second host computer system (not shown). A number of other network types or combinations thereof are capable of facilitating communications between PC-based POS system 130 and one or more host computer systems 140.

Host computer system 140 can be any system capable of processing transactions effectuated in relation to PC-based POS system 130. For example, host computer system 140 can be a money, credit, or value transfer system, a fraud detection system, a bad check detection system, a phone or stored value card sales system, a bill payment system, a bill presentation system, a check acceptance system, a payroll system, a check acceptance system, and the like.

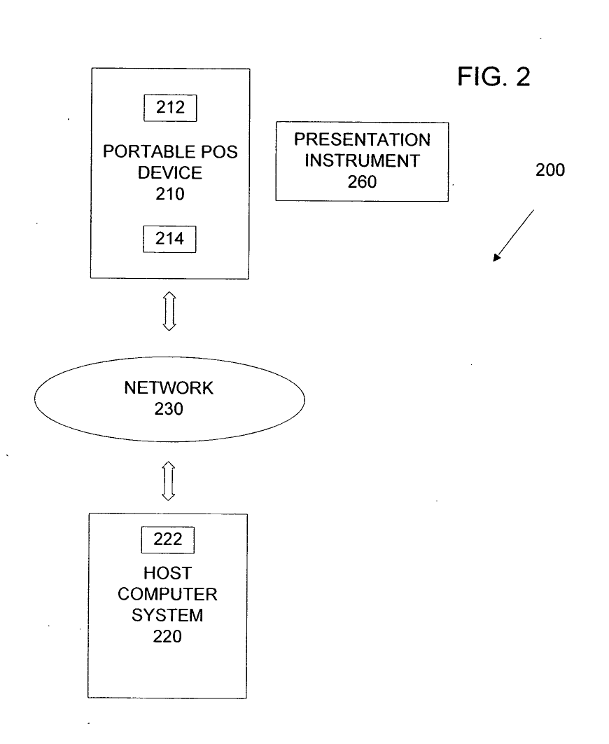

FIG. 2 illustrates another embodiment of a transaction processing system 200. Transaction processing system 200 includes one or more portable POS devices 210 and a host computer system 220. Portable POS device 210 can include an input 212 for receiving a unique identifier from an information storage medium of a presentation instrument 260, and a wireless communication module 214 such as a cellular data modem. Host computer system 220 may include a wireless communication module 222, or may interface with a network or system having wireless communication connectivity capability. Typically, input 212 is coupled with or includes a reader such as a smart card reader, a magnetic strip reader, a bar code reader, a Radio Frequency reader, a Near Field Communication reader, and the like. Wireless communication modules 214 and 222 can be configured to communicate via a wireless network protocol over a network 230 such that the unique identifier can be wirelessly transmitted from portable POS device 212 to host computer system 220. In some cases, the wireless network protocol may include a Bluetooth protocol, a Wireless Fidelity (WiFi) protocol, a Worldwide Interoperability for Microwave Access (WiMax) protocol, a cellular data protocol, and the like. Typically, host computer system 220 processes a transaction, or part of a transaction, based on the unique identifier.

In some embodiments, wireless communication modules 214 and 222 can be configured to communicate via a cellular data protocol such as a Cellular Digital Packet Data (CDPD) protocol, a General Packet Radio Service (GSM/GPRS) protocol, a Code Division Multiple Access (CDMA) protocol, or the like. Exemplary GSM/GPRS protocols include EDGE (Enhanced Data Rates for Global Evolution), Universal Mobile Telecommunications System (UMTS), and High Speed Downlink Packet Access (HSDPA). Exemplary CDMA protocols include Single Carrier Radio Transmission Technology (1xRTT) and Single Carrier Evolution Data Only (1xEvDO).

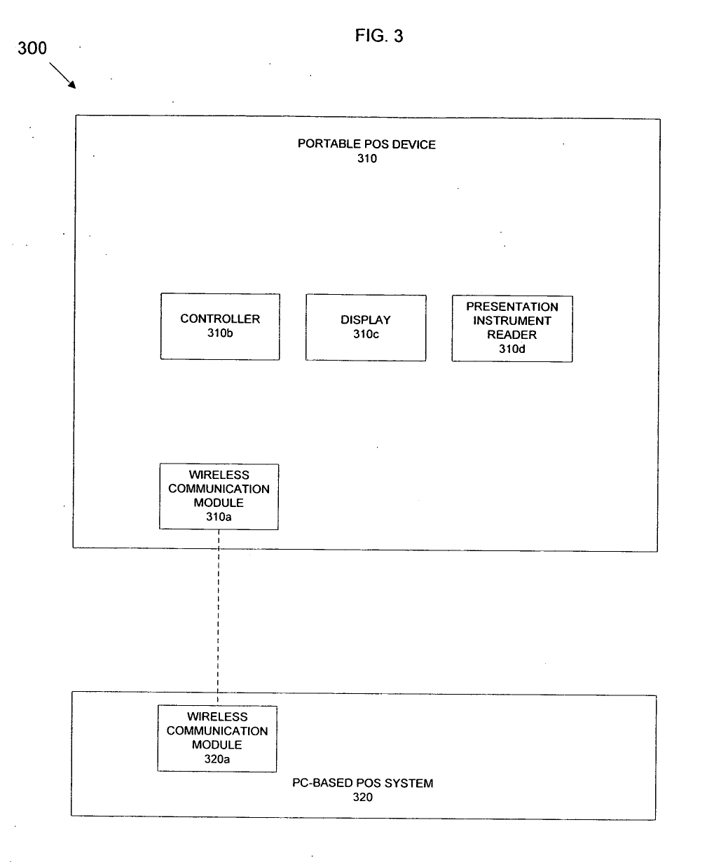

As shown in the embodiment of transaction processing system 300 of FIG. 3, exemplary components that may form part of a portable POS device 310 include a wireless communication module 310a, a controller 310b, a display 310c, and a presentation instrument reader 310d. Other components may include, without limitation to, a keypad, an integrated roll printer, an integrated slip printer, other types of printers, a magnetic-ink character-recognition (“MICR”) reader, a smart card reader, a PIN pad, a security system, a document imager, connection and/or communication ports including Ethernet and USB communications, a modem, a microphone, a speaker, a touch-screen, a card issuer, an operating system, software, and circuit cards, such as, sound cards and/or I/O cards. In addition, interfaces may be provided for connection with an external monitor and/or keyboard. In some embodiments, a PC-based POS system 320 may include all or some of such components. Such components permit transaction processing system 300 to be used by merchants to process multiple types of electronic-payment and other transactions, including credit transactions, debit transactions, check transactions, money-transfer transactions, money-order sales, bill payments, management of customer-loyalty programs, issuance of coupons, acceptance of coupons, issuance of stored value cards, fraud detection associated with a variety of transaction types, and other such functions.

Transaction processing system 300, or individual aspects thereof including portable POS device 310 or PC-based POS system 320, may also incorporate components, features, and/or capabilities of the processing systems, POS devices, and/or base units discussed in commonly owned U.S. patent application Ser. Nos. 10/116,686, 10/116,689, 10/116,733, and 10/116,735, all filed Apr. 3, 2002, Ser. No. 10/358,615 filed Feb. 5, 2003, and Ser. No. 10/370,282 filed Feb. 19, 2003, the entire disclosures of which are hereby incorporated by reference for all purposes. Such components permit POS device 310 to be an interactive tool that allows customers to select their preferred transaction methods and view line-item details of transactions. Such components may also allow customers or merchants to be provided with web-enabled electronic services, such as advertising (e.g., textual, graphics and/or video advertising) and coupons. Transaction system 300 may also be configured to support Bank Identification Number (BIN) management functions including BIN table look-up to determine if a card can be processed as credit, debit, or both, and identification of personal identification number (PIN) capable transactions to allow a merchant to prompt for a PIN number. BIN management procedures can be configured to prompt the cardholder to use their PIN as a way of encouraging their usage of PIN debit payments.

Some embodiments of the present invention include systems and methods for using portable POS devices in relation to various central systems. Such central systems can include electronic-payment systems, money transfer systems, credit transaction systems, check transaction and verification systems, money order sales, stored value systems, management systems associated with customer-loyalty programs, coupon processing systems, fraud detection systems, lottery ticket sales systems, and a number of other such transaction systems.

In particular embodiments, a portable POS device may be used to access or interact with a variety of transaction systems. Further, in some of the embodiments, the transaction systems are developed and maintained by parties apart from those developing and maintaining the portable POS devices. In some embodiments, the transaction systems and portable devices are developed and maintained by the same party. In some embodiments, the portable POS devices include a number of components that can be individually enabled and disabled by the transaction systems depending upon, for example, a particular merchant's affiliation with various transaction systems.

Embodiments of the present invention also provide computerized methods and systems for processing credit card payments and other presentation instrument transactions. In terms of credit cards, a typical credit card transaction involves a number of parties. In addition to the cardholder and the issuer, the parties involved in a credit card transaction may include a merchant, an acquirer and a credit card association such as Visa® or Mastercard®. Often, the acquirer is a business entity, e.g., a commercial bank, that has a business relationship with the merchant and handles credit card transactions from that merchant.

A typical credit card or presentation instrument transaction can include the following steps. First, the amount of the transaction or purchase is calculated, and payment is sought from the cardholder. In the restaurant environment, a server or merchant may input the food and beverage items into the transaction system. With reference to FIG. 1, this can be accomplished, for example, via a PC-based POS system 130 or a portable POS device 110. The cardholder can give their credit card to the server, who then runs the credit card through portable POS device 110. Alternatively, the cardholder may themselves run the credit card through portable POS device 110. The portability of portable POS device 110 allows card processing in full view of the card holder, thus reducing the risk of skimming and other credit card fraud by unscrupulous merchants or their employees. It is understood that in addition to using a credit card, a cardholder may choose to use any suitable presentation instrument or payment method for effecting the payment transaction. Portable POS device 110 can capture credit card and sales information and send such information together with an authorization request to the acquirer. This transmission may be effected via PC-based POS system 130. The acquirer, in turn, processes the information received from portable POS device 110 and/or PC-based POS system 130 and forwards any relevant information and the authorization request to the issuer. The issuer processes the relevant information and the authorization request to determine whether the transaction should be authorized. The issuer then sends an approval or denial code back to the acquirer. The acquirer relays the approval or denial code to portable POS device 110 and/or PC-based POS system 130 for use by the merchant. If the transaction is authorized, the cardholder is allowed to consummate the transaction with the merchant. Typically, at a later time, the accounts maintained by the issuer and the acquirer are settled and reconciled. The end result is that the issuer transfers the transaction amount minus a fee to the acquirer. The acquirer then deducts a fee from the amount received from the issuer. The remaining amount is then transferred by the acquirer to the merchant's account. The issuer also bills the cardholder for the transaction amount by sending the cardholder a credit card statement. The cardholder is typically billed by the issuer on a monthly cycle.

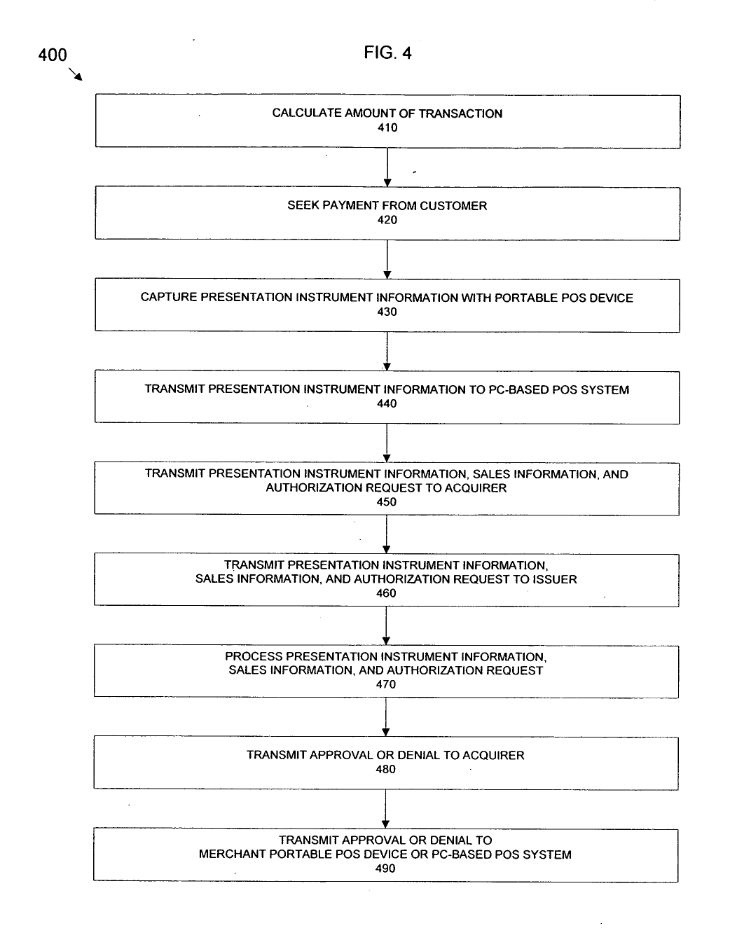

FIG. 4 depicts an exemplary transaction method 400 according to embodiments of the present invention. Step 410 includes calculating the amount of a transaction. This may include, for example, determining the sum total of a restaurant bill, including any food and beverage items. Step 420 includes seeking payment of the amount from a customer. In some embodiments, a waiter or restaurant employee may present the patron with a bill showing the amount of the transaction and any other transaction details. Step 430 involves capturing presentation instrument information with a portable POS device. Often, this is accomplished by swiping a credit card through a reader of the portable POS device. This step may also include receiving authorization or verification information from the customer, such as a PIN number. Step 440 includes transmitting the presentation instrument information to a PC-based POS system. Step 450 includes transmitting presentation instrument information, sales information, and an authorization request to an acquirer. In step 460, presentation information, sales information, and the authorization request are transmitted to an issuer. In step 470, presentation information, sales information, and the authorization request are processed. Step 480 involves transmitting an approval or denial to the acquirer. Step 490 includes transmitting the approval or denial to the merchant portable POS device or PC-based POS system.

The foregoing is merely a general description of a typical credit card transaction. Variations and additional processes may be involved. Exemplary transaction methods and systems are discussed in U.S. patent application Ser. Nos. 10/091,606 filed Mar. 4, 2002, and Ser. No. 10/382,093 filed Mar. 4, 2003, the entire disclosures of which are hereby incorporated by reference for all purposes. It should also be understood that while certain parties, such as the issuer and the acquirer, are described above as performing certain functions, in certain situations, most or all of the functions to be performed by these parties may be performed on their behalf by third parties. In some embodiments, most or all of the functions may be performed by a single party.

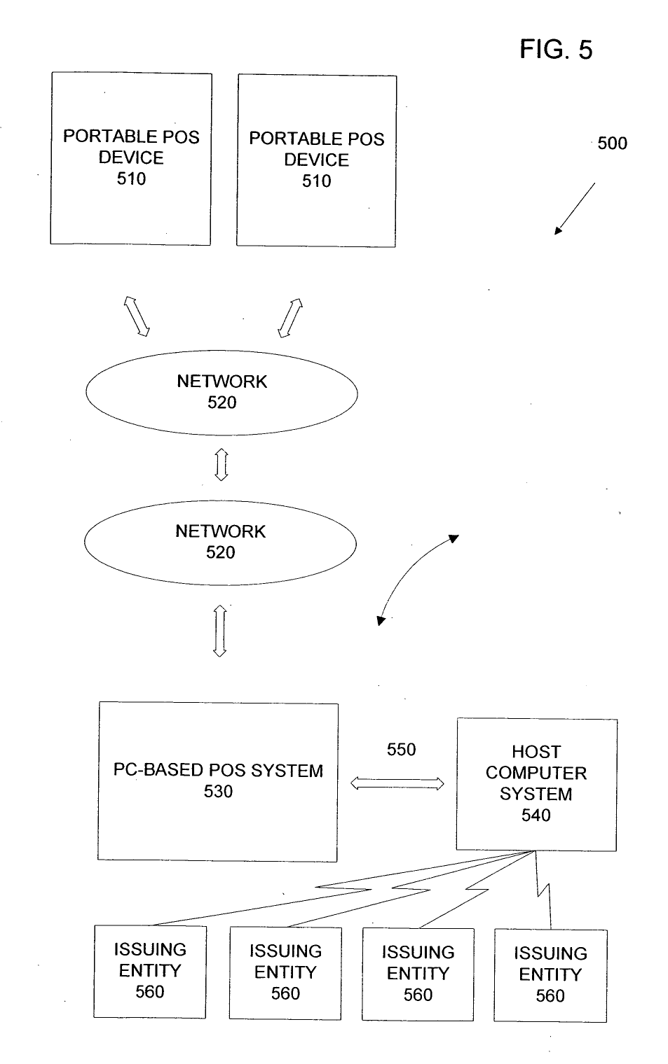

FIG. 5 depicts a transaction processing system 500 according to one embodiment of the present invention. Transaction processing system 500 includes one or more portable POS devices 510, a PC-based POS system 530 or base unit, and a host computer system or authorization processor 540. Portable POS device 510 can include an input for receiving a unique identifier from an information storage medium of a presentation instrument. Portable POS device 510 and PC-based POS system 530 can be configured to communicate via a wireless network protocol over one or more networks 520. Host computer system 540 and PC-based POS system 530 can be configured to communicate via a network 550, which in some embodiments may include a standard POS communication line. Embodiments of the present invention contemplate that transaction processing system 500 provides a complete end-to-end infrastructure to support an entire transaction process, including integration between portable POS device 510 and a PC-based POS system 530, transaction transport, transaction processing and switching, and transaction settlement capabilities. In some embodiments, all of these capabilities are provided or supported by a single entity, such as First Data Corporation, or affiliates thereof. Transaction processing system 500 includes connectivity between host computer system 540 and any of a variety of issuing entities 560, such as MasterCard®, VISA®, STAR® Debit, American Express®, and the like. Thus, transaction processing system 500 can effect processing methods that include forwarding transaction information to issuing entity 560 for authorization purposes, and returning that authorization back to portable POS device 510. For example, exemplary method may include transmitting an authorization request to issuing entity 560 to obtain an authorization response, wherein authorization request is based on a processed transaction, and transmitting the authorization response to portable POS device 510.

Each of the devices or modules of the present invention can include software modules on a computer readable medium that is processed by a processor, hardware modules, or any combination thereof. Any of a variety of commonly used platforms, such as Windows, MacIntosh, and Unix, along with any of a variety of commonly used programming languages, may be used to implement the present invention.

Having described several embodiments, it will be recognized by those of skill in the art that various modifications, alternative constructions, and equivalents may be used without departing from the spirit of the invention. The present invention encompasses systems which can carry out the methods described herein, and similarly encompasses methods for which the systems described herein may be used. Additionally, a number of well known processes and elements have not been described in order to avoid unnecessarily obscuring the present invention. For example, those skilled in the art know how to arrange computing devices into a network and configure communication among them. Accordingly, the above description should not be taken as limiting the scope of the invention, which is defined in the following claims.

1. A method of processing a transaction, comprising:
reading a unique identifier from an information storage medium of a presentation instrument with a portable point of sale device;
transmitting the unique identifier from the portable point of sale device to a PC-based point of sale system according to a wireless network protocol;
transmitting the unique identifier from the PC-based point of sale system to a host computer system;
processing the transaction with the host computer system based on the unique identifier;
transmitting an authorization request to an issuing entity to obtain an authorization response, wherein authorization request is based on the processed transaction; and
transmitting the authorization response to the portable point of sale device.

2. The method according to claim 1, wherein the unique identifier is transmitted from the PC-based point of sale base terminal to the host computer system via a non-wireless transaction processing network.

3. The method according to claim 1, comprising displaying transaction information on the portable point of sale device.

4. The method according to claim 1, comprising accepting a customer payment authorization with the portable point of sale device.

5. The method according to claim 1, wherein the presentation instrument comprises a member selected from the group consisting of a PIN debit instrument, a signature debit instrument, a credit instrument, or a stored value instrument.

6. The method according to claim 1, wherein the unique identifier from the portable point of sale device is transmitted to the PC-based point of sale system according to a protocol selected from the group consisting of a Bluetooth protocol, a Wireless Fidelity (WiFi) protocol, a Worldwide Interoperability for Microwave Access (WiMax) protocol, and a cellular data protocol.

7. The method according to claim 1, comprising reading the unique identifier with a reader of the portable point of sale device, wherein the reader comprises a member selected from the group consisting of a smart card reader, a magnetic strip reader, a bar code reader, a Radio Frequency reader, and a Near Field Communication reader.

8. A method of processing a transaction, comprising:
reading a unique identifier from an information storage medium of a presentation instrument with a portable point of sale device;
transmitting the unique identifier from a cellular data modem of the portable point of sale device to host computer system; and
processing the transaction with the host computer system based on the unique identifier.

9. The method according to claim 8, comprising displaying transaction information on the portable point of sale device.

10. The method according to claim 8, comprising accepting a customer payment authorization with the portable point of sale device.

11. The method according to claim 8, wherein the presentation instrument comprises a member selected from the group consisting of a PIN debit instrument, a signature debit instrument, a credit instrument, and a stored value instrument.

12. The method according to claim 8, wherein the unique identifier from the portable point of sale device is transmitted to the PC-based point of sale system according to a cellular data protocol.

13. The method according to claim 8, comprising reading the unique identifier with a reader of the portable point of sale device, wherein the reader comprises a member selected from the group consisting of a smart card reader, a magnetic strip reader, a bar code reader, a Radio Frequency reader, and a Near Field Communication reader.

14. A system for processing a transaction, comprising:
a portable point of sale device comprising:
an input for receiving a unique identifier from an information storage medium of a presentation instrument, and
a first wireless communication module;
a PC-based point of sale system comprising:
an input for receiving the unique identifier from the information storage medium of the presentation instrument, and
a second wireless communication module configured to communicate with the first wireless communication module via a wireless network protocol such that the unique identifier can be wirelessly transmitted from the portable point of sale device to the PC-based point of sale, and
a host computer system configured to receive the unique identifier from the PC-based point of sale system and to process a transaction based on the unique identifier.

15. The system according to claim 14, wherein the portable point of sale device is configured to accept a presentation instrument selected from the group consisting of a PIN debit instrument, a signature debit instrument, a credit instrument, and a stored value instrument.

16. The system according to claim 14, wherein the portable point of sale device is configured to prompt a user for a PIN number.

17. The system according to claim 14, wherein the wireless network protocol comprises a cellular data protocol selected from the group consisting of a Cellular Digital Packet Data (CDPD) protocol, a General Packet Radio Service (GSM/GPRS) protocol, and a Code Division Multiple Access (CDMA) protocol.

18. The system according to claim 14, wherein the portable point of sale device comprises a PIN pad.

19. The system according to claim 14, wherein the portable point of sale device comprises a member selected from the group consisting of a smart card reader, a magnetic strip reader, a bar code reader, a Radio Frequency reader, and a Near Field Communication reader.

20. A transaction processing method, comprising:
calculating an amount of a transaction;
capturing a presentation instrument information from a customer presentation instrument with a portable POS device;
transmitting the presentation instrument information to a PC-based POS system;
transmitting the presentation instrument information, a sales information, and an authorization request to an acquirer;
transmitting the presentation information, the sales information, and the authorization request to an issuer;
processing the presentation information, the sales information, and the authorization request to determine an approval or a denial;
transmitting the approval or the denial to the acquirer; and
transmitting the approval or the denial to the PC-based POS system.
